(19) United States
(12) Patent Application Publication
(10) Pub. No.: US 2016/0162650 A1
(43) Pub. Date: Jun. 9, 2016

(54) METHOD FOR AUTOMATING MEDICAL BILLING

(71) Applicants: Robert J. Newbold, Canton, OH (US); Scott V. Watkins, Cumberland, MD (US)

(72) Inventors: Robert J. Newbold, Canton, OH (US); Scott V. Watkins, Cumberland, MD (US)

(21) Appl. No.: 14/563,737

(22) Filed: Dec. 8, 2014

(51) Int. Cl. G06F 19/00; G06Q 20/14; G06Q 50/22; G06F 17/30

(52) U.S. Cl. CPC G06F 19/328; G06F 17/30011; G06F 19/322; G06Q 20/14; G06Q 50/22

(57) ABSTRACT

A system and method provide for automatic billing for medical services or supplies. Processors may search patient medical files and medical documents to find keys and/or codes associated with the medical services or supplies. Processors may determine costs associated with the medical services or supplies based on the found medical codes. Processors may also create billing documents including all or part the cost and automatically send the billing documents to entities responsible for payment of the medical services or supplies.

### BACKGROUND OF THE INVENTION

1. Field of Invention

The current invention relates generally to apparatus, systems and methods for medical billing. More particularly, the apparatus, systems and methods relate to generating medical bills based on medical codes. The apparatus, systems and methods may provide a way to search medical records for assigning medical codes or identifying applicable diagnosis and CPT codes and then automatically generate billing documents based upon the found medical codes and uploading the same encrypted codes to third party payors.

2. Description of Related Art

Modem medical practice uses medical codes which correspond to medical services and medical supplies. It is often the case in current medical practice that a doctor or a doctor's assistant uses a computer to enter medical information into a computer medical file assigned to or associated with a given patient while the patient is being seen by the doctor or shortly thereafter. Such medical information may include medical services provided, diagnosis and/or medical supplies. The medical services may include a medical diagnosis or medical treatment. In most cases, a specialized medical coding person may ascertain medical codes associated with these medical services or supplies and use those medical codes used for billing purposes. Insurance companies may or may not pay for the medical services or supplies depending on the particular medical codes submitted and supported by medical records. For example, if the code is for a preventative treatment, a medical insurance plan may pay the associated bill, but if the code pertains to a non-preventative illness/condition, the medical insurance plan may not cover the bill, or may only cover a portion of bill after a deductible amount has been satisfied.

### SUMMARY

In one aspect, the invention may provide a method comprising the steps of searching a medical document to determine medical codes and/or with a medical code search processor to find one or more medical codes associated respectively with one or more medical services or medical supplies; determining with a cost determination processor a price associated with the one or more medical services or medical supplies based on the one or more medical codes; and creating with a billing processor a first billing document which provides at least a portion of the price.

In another aspect, the invention may provide a system comprising a medical code search processor programmed to search a medical document for one or more medical codes associated respectively with one or more medical services or medical supplies; a cost determination processor programmed to determine a price of the one or more medical services based on the one or more medical codes; and a billing processor programmed to automatically generate one or more billing documents including at least a portion of the price.

### BRIEF DESCRIPTION OF SEVERAL VIEWS OF THE DRAWINGS

One or more sample embodiments that illustrate the best mode(s) are set forth in the drawings and in the following description. The appended claims particularly and distinctly point out and set forth the invention.

FIG. 1 is a diagrammatic view of a sample medical billing system.

FIG. 2 is a flowchart of a sample medical billing method.

Similar numbers refer to similar parts throughout the drawings.

### DETAILED DESCRIPTION

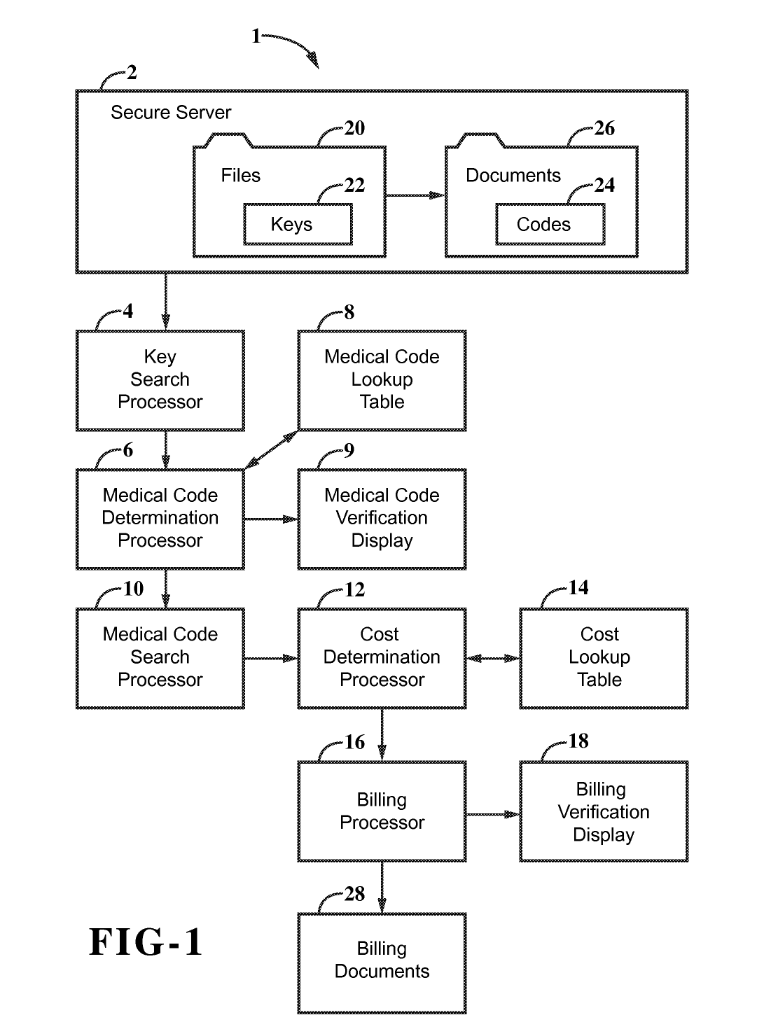

FIG. 1 shows a sample embodiment of an automatic medical billing system 1 for automatically generating medical billing. Medical billing system 1 may include a secure server 2, a key search processor 4, a medical code determination processor 6, a medical code lookup table 8, a medical code verification display 9, a medical code search processor 10, a price or cost determination processor 12, a medical cost lookup table 14, a billing processor 16 and a billing verification display 18. Medical code lookup table 8 and cost lookup table 14 may be part of a database residing in a server or located in other places as understood by those of ordinary skill in the art.

Key search processor 4 may be in electrical or wireless communication with server 2 or another server or computer in which files 20 are stored so that processor 4 may access files 20. Medical code determination processor 6 may be in electrical or wireless communication with server 2 or another server or computer in which documents 26 are stored so that processor 6 may access documents 26. Medical code determination processor 6 may also be in electrical or wireless communication with medical code lookup table 8 so that processor 6 may access lookup table 8. Medical code determination processor 6 may also be connected to or in electrical or wireless communication with medical code verification display 9. Medical code search processor 10 may be in electrical or wireless communication with medical code determination processor 6. Cost determination processor 12 may be in electrical or wireless communication with medical code search processor 10 and billing processor 16. Cost determination processor 12 may also be in electrical or wireless communication with cost lookup table 14 so that processor 12 may access lookup table 14. Billing processor 16 may also be connected to or in electrical or wireless communication with billing verification display 18.

Medical code lookup table 8 may be populated with a large number (e.g., hundreds or thousands) of medical codes 24 which respectively represent or are associated with medical services or medical supplies. Cost lookup table 14 may be populated with a large number (e.g., hundreds or thousands) of costs or prices respectively associated with medical codes 24 whereby the costs or prices are respectively for the corresponding medical services or medical supplies.

“Processor” and “Logic”, as used herein, include but are not limited to hardware, firmware, software and/or combinations of each to perform a function(s) or an action(s), and/or to cause a function or action from another logic, method, and/or system. For example, based on a desired application or need, logic and/or processor may include a software controlled microprocessor, discrete logic, an application specific integrated circuit (ASIC), a programmed logic device, a memory device containing instructions, or the like. Logic and/or a processor may include one or more gates, combinations of gates, or other circuit components. Logic and/or a processor may also be fully embodied as software. Where multiple logics and/or processors are described, it may be possible to incorporate the multiple logics and/or processors into one physical logic (or processor). Similarly, where a single logic and/or processor is described, it may be possible to distribute that single logic and/or processor between multiple physical logics and/or processors.

The operation of system 1 is now described. In short, key search processor 4 may be used to search a patient's medical file or files 20 to find keys 22 associated with medical services (e.g., medical diagnosis or treatment) and/or medical supplies. Medical code determination processor 6 may use keys 22 to determine medical codes 24, which may involve the use of medical code lookup table 8, and to create medical documents 26. Medical code search processor 10 may be used to find medical codes 24 by searching medical documents 26. Cost determination processor 12 may be used to find and/or calculate a price or cost of medical services or supplies based on medical codes 24. Finding and/or calculating this price or cost may involve the use of medical cost lookup table 14. Billing processor 16 may be configured or programmed to produce billing documents 28 based on the cost or costs determined by cost determination processor 16, and then send billing documents 28 to request payment from one or more entities responsible for such payment.

Because billing system 1 generates medical bills that are based on medical codes 24, an introduction to medical coding is presented before discussing the operation of system 1 further. Medical coding or medical classification is the process of transforming descriptions of medical services (such as medical diagnoses and procedures) into universal medical codes or code numbers. A patient's diagnoses and procedures are usually taken from a variety of sources within the healthcare record, such as the transcription of the physician's notes, laboratory results, radiologic results, and other sources.

Diagnosis codes are also used to track diseases and other health conditions, inclusive of chronic diseases such as diabetes mellitus and heart disease, and contagious diseases such as norovirus, the flu (various types of flu viruses) and athlete's foot. These diagnosis and procedure codes are used by government health programs, private health insurance companies, workers' compensation carriers and others.

Medical classification systems are used for a variety of applications in medicine, public health and medical informatics, including: statistical analysis of diseases and therapeutic actions; reimbursement, for example, based on diagnosis-related groups; knowledge-based and decision support systems; and the direct surveillance of epidemic or pandemic outbreaks. There are country-specific standards and international classification systems.

Many different medical classifications exist, though they are primarily divided into two main groupings: statistical classifications and nomenclatures. A statistical classification brings together similar clinical concepts and groups them into categories. The number of categories is limited so that the classification does not become too large. One example is used by the International Statistical Classification of Diseases and Related Health Problems (known as ICD).

In the United States, ICD is widely used along with Standardized Electronic Health Record (EHR) systems and the Systematized Nomenclature of Medicine (SNOMED). ICD is the international standard diagnostic tool for epidemiology, health management and clinical purposes. The ICD is maintained by the World Health Organization (WHO), the directing and coordinating authority for health within the United Nations System. The lCD is designed as a health care classification system, providing a system of diagnostic codes for classifying diseases, including nuanced classifications of a wide variety of signs, symptoms, abnormal findings, complaints, social circumstances, and external causes of injury or disease. This lCD system is designed to map health conditions to corresponding generic categories together with specific variations, assigning for these a designated code, up to six characters long. Thus, major categories are designed to include a set of similar diseases.

For example, the ICD groups diseases of the circulatory system into one “chapter” known as Chapter IX, covering codes 100-199. One of the codes in this chapter (147.1) has the code title (rubric) Supraventricular tachycardia. However, there are several other clinical concepts that are also classified here. Among them are atrial paroxysmal tachycardia, atrioventricular paroxysmal tachycardia, junctional paroxysmal tachycardia and nodal paroxysmal tachycardia.

SNOMED is a clinical terminology designed to capture and represent patient data for clinical purposes. SNOMED is the most widely recognized nomenclature in healthcare. The current version, SNOMED Clinical Terms (SNOMED CT), is intended to provide a set of concepts and relationships that offer a common reference point for comparison and aggregation of data about the health care process. SNOMED CT is often described as a reference terminology. SNOMED CT contains more than 311,000 active concepts with unique meanings and formal logic-based definitions organized into hierarchies. SNOMED CT is designed to be managed by computer, and it has complex relationship concepts.

SNOMED CT is a statistical classification system used to assign diagnostic and procedural codes in order to produce coded data for statistical analysis, epidemiology, reimbursement and resource allocation. SNOMED/SNOMED CT use standardized definitions and form a common medical language used within EHR systems. SNOMED CT enables information input into EHR during the course of patient care, while ICD facilitates information retrieval, or output, for secondary data purposes.

SNOMED CT is used in a number of different ways. It captures clinical information at the level of detail needed for the provision of healthcare. Through the sharing of data, SNOMED CT can reduce the need to repeat health history at each new encounter with a healthcare professional. Additionally, SNOMED CT allows for information to be recorded by different people in different locations and combined into simple information views within the patient record. A common terminology decreases the potential for differing interpretation of information. Electronic recording in a common way reduces errors and can help to ensure completeness in recording all relevant data. Using standardized information makes analysis easier and supports quality, cost effective practice, research and future clinical guideline development. SNOMED CT's use of clinical terminology allows a health care provider to identify patients based on specified coded information and more effectively manage screening, treatment and follow up.

The EHR or electronic medical record (EMR) is a systematic collection of electronic health information about an individual patient or population. It is a record in digital format that is theoretically capable of being shared across different health care settings. In some cases, this sharing can occur by way of network-connected, enterprise-wide information systems and other information networks or exchanges. EHRs may include a range of data, including demographics, medical history, medication and allergies, immunization status, laboratory test results, radiology images, vital signs, personal statistics like age and weight, and billing information.

The EHR or EMR system is designed to represent data that accurately captures the state of the patient at all times (assuming current updating). This system allows for an entire patient history to be viewed without the need to track down the patient's previous (and potentially voluminous) medical record and assists in ensuring data is accurate, appropriate and legible. It reduces the chances of data replication because there is only one modifiable file, which means the file is essentially always up to date and eliminates the issue of lost forms or paperwork. The use of a single file containing all the information is much more effective when extracting medical data for the examination of possible trends and long term changes in the patient.

SNOMED CT and ICD are designed for different purposes. As a core terminology for the EHR, SNOMED CT provides a common, consistent language that enables a consistent way of capturing, sharing, and aggregating health data across specialties and sites of care. SNOMED CT is highly detailed terminology designed for input of medical records and for reporting. ICD is typically used for external reporting requirements or other uses where data aggregation is advantageous, such as measuring the quality of care, monitoring resource utilization or processing claims for reimbursement. SNOMED provides clinically-based documents for whatever is needed for patient care and has better clinical coverage than ICD. ICD's focus is statistical with less common diseases getting lumped together in “catch-all” categories, which result in loss of information. SNOMED CT is used directly by healthcare providers during the process of care, whereas ICD is used by coding professionals after the episode of care. SNOMED CT is a multiple hierarchy system, whereas ICD is a single hierarchy system. SNOMED CT concepts are defined logically by their attributes, whereas there are only textual rules and definitions in ICD.

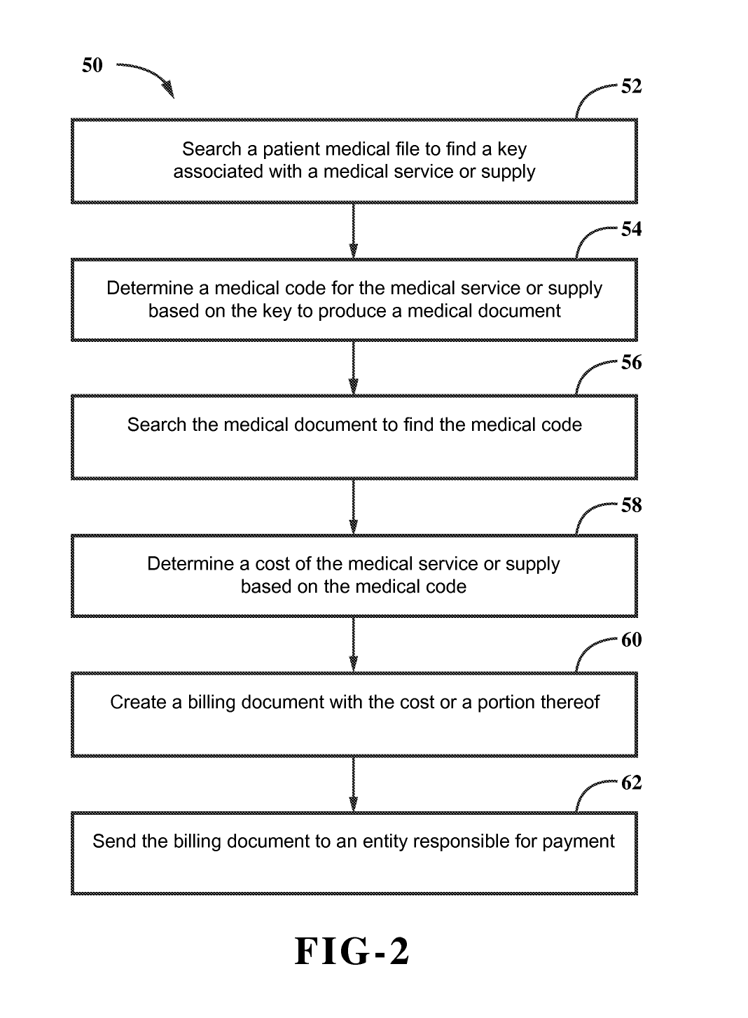

The operation of system 1 is now discussed in more detail. A sample method 50 is shown in FIG. 2 and may include the various steps in blocks 52-62. A given method may include some or all of these steps, which may be performed in the order shown or otherwise depending on the given step. Method 50 may include searching a patient medical file 20 to find a key 22 associated with a medical service or supply (block 52). Key search processor 4 may be configured or programmed to effect or perform this searching step. Processor 4 may search one or more patient's medical file or files 20 to find one or more keys 22. Such patient medical files may have been formed with a computer and saved in a database which may be in server 2. For instance, such files or records 20 may include information that was entered via a computer by a doctor, a nurse, a staff member of a doctor, or any healthcare professional or assistant thereof responsible for recording/inputting such medical information related to a given patient. Such medical information may correspond to various medical services or supplies provided to the given patient for which the medical file or record 20 has been created. Within this medical information will be keys 22, each of which may include, for instance, keywords or key phrases with may be, e.g., numeric, alphabetical or alphanumeric, and which are typically associated with or indicative of a given medical service or supply.

After a given key 22 has been found, the method may include determining a medical code 24 for the medical service or supply based on the key 22 to produce a medical document 26 (block 54). Medical code determination processor 6 may be configured or programmed to effect or perform this determining step. More particularly, processor 6 may use the given key 22 that was found and use that key 22 as a basis for searching for and matching that key 22 with a medical code 24 which thus corresponds to that key 22 and the medical service or supply represented by that key 22. This medical code 24 is thus also representative of the medical service or supply represented by key 22. Processor 6 may search medical code lookup table 8 to find the given medical code 24 which represents or most closely represents the corresponding key 22 and medical service or supply. Medical codes 24 may be or may include the SNOMED codes.

In some cases, due to the complexity of accurately matching a given key 22 with a given medical code 24, it may be desirable to have human verification of a given match to ensure that the correct code 24 is being used for the given medical service or supply. Thus, processor 6 may communicate the given medical service or supply and the found key 22 and code 24 to medical code verification display 9 so that a medical code verification person may view them on visual display 9. Processor 6 may cause a verification prompt to be provided or displayed on visual display 9 as to whether the key or code is correct or accurately represents the medical service or supply which processor 6 has determined. The verification person may then verify or check to see whether the key and code are correct or accurately represent the medical service or supply which processor 6 has determined. If so, the verification person may indicate to processor 6 that the given code 24 is correct, such as via inputting a “correct” indicator or response to the verification prompt via a computer input device (mouse, keyboard, etc). If not, the verification person may indicate to processor 6 that the given code 24 is incorrect, such as via inputting an “incorrect” indicator or response to such the prompt in a similar manner, and may also similarly input the correct medical code 24 after the verification person has determined what that code should actually be. After the correct medical code 24 has been determined (with or without verification by a verification person), the medical code 24 may be saved in a database (such as in server 2) in a corresponding patient medical document 26 of the given patient. This medical document 26 may include some or all of the information from the corresponding patient file 20.

After medical document 26 has been created, medical code search processor 10 may search the medical document 26 to find one or more medical codes 24 (block 56). Processor 10 may thus be configured or programmed to perform this searching step. Various medical codes 24 may be in secure server 2 and be associated respectively with particular medical services and/or supplies of respective particular patients at a particular medical facility. Search processor 10 can search for medical codes 24 which may be numeric, alphabetical or alphanumeric medical codes. Processor 10 may search one or more medical documents 26 for various medical codes 24 (e.g., keywords and/or numbers) and provide all of the found medical codes 24 to cost determination processor 12. Whether a given medical code 24 was found one or more times (which may be numerous times), search processor 10 may also indicate to determination processor 12 how many times (or a number of times) that the given medical code 24 was found. The medical documents searched by search processor 10 may be SNOMED/SNOMED CT documents, similarly coded documents and similar documents as understood by those of ordinary skill in the art.

After one or more medical codes 24 have been found, processor 10 may send the codes 24 to cost determination processor 12, which is configured or programmed to determine a cost or price of the medical service or supply based on the medical code or codes 24 (block 58) received from processor 10. Cost determination processor 12 can determine a price or cost based on medical codes 24 in any method as understood by one of ordinary skill in this art, Processor 12 may look up and/or calculate a price or cost associated with or assigned to a given medical code 24 to generate the total cost of one or more medical services or medical supplies represented by the given medical code.

For example, cost determination processor 12 may access cost lookup table 14 to determine the cost or costs of medical services or supplies. For example, if a first medical supply such as a bandage of a first size is detected, processor 12 may look up in cost lookup table 14 a price or cost of the first medical supply/bandage of the first size. By way of further example, when five of a second medical supply such as a bandage of a second size are detected, processor 12 may look up a price or cost of the second medical supply/bandage of the second size in cost lookup table 14 and multiply this price or cost times the number (here, five) of the second medical supply/bandages to determine the total price or cost of the number (five) bandages of the second size. The cost for one or more the medical services and/or supplies may be a single fixed cost or may depend on other medical codes found in relevant documents searched by search processor 10 and/or other variables as discussed below. Cost lookup table 14 may thus be configured or programmed to return a cost associated with a particular medical code when presented with the particular medical code by cost determination processor 12.

Search processor 10 may search medical documents in secure server 2 for medical codes 24 that indicate the type of medical facility at which a medical service was performed (which may have required one or more medical supplies) to more accurately determine the cost of the medical service and/or supplies. For example, processor 10 may find the code for “office visit” and then provide this found code to cost determination processor 12, which may then find and/or calculate a price or cost for the medical services and/or supplies provided to the patient at a doctors office (i.e., an office visit). If, on the other hand, search processor 10 determines that the medical services and/or supplies occurred or were provided at a hospital by finding an associated medical code (e.g., for “hospital visit”), then cost determination processor 12 may find/calculate a different (typically larger) price or cost to be paid than at a doctors office.

Cost determination processor 12 may use additional information provided by several medical codes 24, which may allow processor 12 to more accurately prepare an estimate of a price or cost of a medical treatment. For example, if a patient receives surgery at a hospital, search processor 10 may find several different medical codes for various types of a medical supply and/or a medical procedure or service, such as, for instance: “anesthetic”, a surgical procedure which may include surgical materials used to perform that procedure, “bandage”, “hospital room” and the like, whereby processor 10 may provide all of the corresponding different types of codes to cost determination processor 12. Cost determination processor 12 may then find and/or calculate a cost for each medical supply, procedure or service. For instance, processor 12 may calculate the price of one or more of a medical supply such as a bandage, which may involve determining or ascertaining the bandage size and the number of bandages of that size used, assigning a cost for each of such bandages, and performing a mathematical function to provide the price (such as by adding, or by multiplying the number times the cost for each medical supply/bandage of that size). Processor 12 may also determine how many nights the patient stayed in the hospital, based on appropriate medical codes 24 and keywords, and then assign a cost for the hospital room. Cost determination processor 12 may also, based on a medical code(s) for anesthesia, determine a price or cost of anesthesia administered to the patient. Processor 12 may also similarly determine a price or cost for a surgery performed on a patient, and each of the tools, machines and any other items or supplies used to perform the surgery based on medical codes 24 indicative thereof. In some cases, cost determination processor 12 may determine based on medical codes 24 if a medical procedure was a preventative procedure or a non-preventative procedure.

In some circumstances, cost determination processor 12 may require that more than one of a given medical code 24 be found in the medical documents in order to calculate a medical service/supply cost, wherein the given medical code 24 represents a given medical service or medical supply. For example, cost determination processor 12 may require that a given medical code appear or be found a threshold number of two or more times in the medical document in order to be used in determining the price thereof. Processor 10 or 12 may be configured or programmed to meet this requirement. That is, code search processor 10 may be programmed to pass on the given medical code 24 to processor 12 only if the threshold number is met, or cost determination processor 12 may be programmed to use the given medical code to determine the cost only if the threshold number is met when processor 10 has sent the given medical code to processor 12. The threshold number may be, for instance, two, three, four, five, six, seven, eight, nine, ten or more of a given medical code.

After the cost or price of a given medical service or supply is found or calculated, cost determination processor 12 communicates the cost or price to billing processor 16, which may be configured or programmed to automatically create a billing document 28 with the cost or a portion thereof (block 60) for the medical service or supply. Billing document 28 thus may include, provide or list at least a portion of the cost or price. Billing processor 16 may also be configured or programmed to automatically send or cause the sending of the billing document to an entity responsible for payment (block 62) of the price or portion of the price for the medical service or supply. This entity may be an insurance company and/or one or more individual(s) such as the patient or guardian of the patient, or another entity (which is not the insurance company) responsible for paying the price (or a portion thereof) for the service and/or supplies. For example, a medical code for anesthesia may indicate to billing processor 16 to prepare a billing document to be provided to the insurance company or other appropriate entity that is to pay the cost of the anesthesia, whereas medical codes for the hospital room and associated stay may indicate to billing processor 16 to prepare billing documents to be provided to a different entity that is responsible for paying the cost (or a portion thereof) associated with the hospital room and stay.

Processor 16 may cause paper billing documents 28 to be prepared and mailed or sent and/or prepare electronic billing documents 28 to be sent electronically through a suitable electronic transmission system, which may include wired and wireless transmission pathways. Such a transmission system may include email or other known transmission systems. Paper documents may be sent through any suitable delivery service, such as the U.S. Postal Service, United Parcel Service (UPS), FedEx and so forth.

Where processor 12 determines that a medical service or procedure was a preventative procedure, billing processor 16 may generate a billing document 28 with the cost or portion thereof associated with the preventative procedure and send that billing document 28 to an insurance company or a first entity responsible for payment of the preventative procedure cost. Where processor 12 determines that a medical service or procedure was a non-preventative procedure, billing processor 16 may generate a billing document 28 with the cost or portion thereof associated with the non-preventative procedure and send that billing document 28 to a different second entity responsible for payment of the non-preventative procedure cost.

Billing verification display 18 may be connected to or in communication with billing processor 16 so that billing documents 28 created by processor 16 may be projected or displayed on billing verification display 18. Before sending the billing document 28 to an entity responsible for payment, a verification person may thus view on visual display 18 billing documents 28 including the price or portion of the price of the medical services and/or medical supplies to verify or check whether the price or portion of the price is correct or accurately represents the price or cost of the medical services and/or supplies which is to be paid by a given entity to whom the document 28 is to be sent for payment.

Thus, processor 16 may be programmed to cause a verification prompt to be provided or displayed on visual display 18 as to whether the price or portion thereof is correct. The billing verification person may then verify or check to see whether the price or portion of the price is correct. If so, the verification person may indicate to processor 16 that the price/portion thereof is correct, such as via inputting a “correct” indicator or response to the verification prompt on display 18 via a computer input device (mouse, keyboard, etc). If not, the verification person may indicate to processor 16 that the given price/portion thereof is incorrect, such as via inputting an “incorrect” indicator or response to the prompt in a similar manner, and may also similarly input the correct price/portion thereof after the verification person has made that determination. Processor 16 may be programmed to, in the case where the verification person inputs an “incorrect” indicator or response, cause a correct price entry prompt to be provided or displayed on visual display 18 where the verification person can enter the correct price.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative samples shown and described. Thus, this application is intended to embrace alterations, modifications, and variations that fall within the scope of the appended claims.

Moreover, the description and illustration of the invention is an example and the invention is not limited to the exact details shown or described. References to “the sample embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the example embodiment” does not necessarily refer to the same embodiment, though it may.

1. A method comprising the steps of:
searching a medical document with a medical code search processor to find one or more medical codes associated respectively with one or more medical services or medical supplies;
determining with a cost determination processor a price associated with the one or more medical services or medical supplies based on the one or more medical codes; and
creating with a billing processor a first billing document which provides at least a portion of the price.

2. The method of claim 1 further comprising the step of:
automatically sending the billing document to an entity responsible for payment of the at least a portion of the price.

3. The method of claim 2 wherein the step of automatically sending the first billing document comprises at least one of the steps of:
sending the first billing document as a paper document; and
sending the first billing document as an electronic document.

4. The method of claim 1 further comprising the step of:
automatically sending the billing document to a medical insurance company.

5. The method of claim 1 further comprising the steps of:
determining that a first medical code of the one or more medical codes represents a first medical supply;
ascertaining a number of the first medical codes found in the step of searching; and
calculating the price based on the number.

6. The method of claim 5 further comprising the steps of:
multiplying the first supply cost times the number to determine a first supply cost total; and
calculating the price based on the first supply cost total.

7. The method of claim 1 wherein the step of determining comprises looking up a first cost of the one or more medical services or medical supplies in a cost lookup table.

8. The method of claim 1 further comprising the steps of:
determining that first and second medical codes of the one or more medical codes respectively represent first and second medical services or medical supplies;
looking up in a cost lookup table a first cost associated with the first medical code and a second cost associated with the second medical code; and
calculating the price based on the first and second costs.

9. The method of claim 1 wherein the medical codes are Systematized Nomenclature of Medicine (SNOMED) codes.

10. The method of claim 1 further comprising the steps of:
creating with the billing processor a second billing document which includes at least part of the price;
sending the first billing document to an insurance company; and
sending the second billing document to another entity that is not the insurance company.

11. The method of claim 1 further comprising the step of:
displaying the at least a portion of the price on a visual display.

12. The method of claim 11 further comprising the step of:
providing on the visual display a verification prompt as to whether the at least a portion of the price is correct.

13. The method of claim 1 further comprising the step of:
providing on a visual display a verification prompt as to whether the one or more medical codes accurately represent the one or more medical services or medical supplies.

14. The method of claim 1 wherein the step of determining the price is based on determining from the medical codes whether the medical services were for a preventative procedure or a non-preventative procedure.

15. The method of claim 1 further comprising the steps of:
searching the medical document to determine a type of medical facility at which the one or more medical services or medical supplies were provided; and
wherein the step of determining the price comprises determining the price based on the type of medical facility.

16. The method of claim 1 wherein a given medical code of the one or more medical codes represents a given medical service or medical supply and must be found in the step of searching a threshold number of two or more times in order for the given medical code to be used in the step of determining the price.

17. The method of claim 1 wherein the medical document is in an Electronic Health Record (EHR) system.

18. The method of claim 1 further comprising the steps of:
searching a patient medical file with a key search processor to find one or more keys; and
determining the one or more medical codes for the one or more medical services or medical supplies based on the one or more keys.

19. The method of claim 18 wherein the step of determining the one or more medical codes comprises looking up in a medical code lookup table the one or more medical codes which correspond to the one or more keys.

20. A system comprising:
a medical code search processor programmed to search a medical document for one or more medical codes associated respectively with one or more medical services or medical supplies;
a cost determination processor programmed to determine a price of the one or more medical services based on the one or more medical codes; and
a billing processor programmed to automatically generate one or more billing documents including at least a portion of the price.
